(19) United States
(12) Patent Application Publication
(10) Pub. No.: US 2025/0383797 A1
(43) Pub. Date: Dec. 18, 2025

(54) SYSTEMS AND METHODS FOR IMPROVED DATA TRANSFER

(71) Applicant: QUALCOMM Incorporated, San Diego, CA (US)

(72) Inventors: Sang TRAN, Encinitas, CA (US); Hung VUONG, Coronado, CA (US); Rongtian ZHANG, San Diego, CA (US)

(21) Appl. No.: 18/741,596

(22) Filed: Jun. 12, 2024

(51) Int. Cl. G06F 3/06

(52) U.S. Cl. CPC G06F 3/0631; G06F 3/0613; G06F 3/0634; G06F 3/0683

(57) ABSTRACT

An apparatus includes a shared data bus coupled to a non-volatile memory via a non-volatile memory data bus. The shared data bus is also coupled to a volatile memory via a volatile memory data bus. The non-volatile memory data bus is a first subset of the shared data bus, and the volatile memory data bus is a second subset of the shared data bus. The apparatus additionally includes a memory controller coupled to the shared data bus and both the non-volatile memory and the volatile memory via the shared data bus.

FIELD OF THE DISCLOSURE

Aspects of the present disclosure generally relate to data transfer systems, and more particularly to systems and methods for improved data transfer.

### BACKGROUND

In computing systems, memory may be volatile memory or non-volatile memory. Volatile memory, such as random access memory (RAM), specifies continuous power to maintain stored data. Volatile memory is primarily used for temporary storage while a processor is performing computations. Non-volatile memory, such as NOR memory and NAND memory used in solid state drives (SSDs) and hard drives, retains data even when powered off, making non-volatile memory preferable for long-term data storage. Non-volatile memory is generally slower in data access compared to volatile memory but is useful for preserving user data, applications, and the operating system across power cycles, providing persistence that volatile memory lacks.

A host device, such as a system-on-a-chip (SoC), may be coupled to memory via command buses, data buses, and clock buses. Command buses transmit operational instructions from the SoC to memory. The SoC may use a command bus to direct how data should be handled, whether stored, erased, or modified. Data buses facilitate the transfer of data back and forth between the SoC and the memory, enabling the system to access and utilize the data as specified for processing tasks. Clock buses provide timing signals to synchronize data transfers and operations across the system.

### SUMMARY

According to aspects of the present disclosure, an apparatus includes a shared data bus coupled to a non-volatile memory via a non-volatile memory data bus. The shared data bus is also coupled to a volatile memory via a volatile memory data bus. The non-volatile memory data bus is a first subset of the shared data bus, and the volatile memory data bus is a second subset of the shared data bus. The apparatus additionally includes a memory controller coupled to the shared data bus and both the non-volatile memory and the volatile memory via the shared data bus.

Other aspects of the present are directed to a method. The method includes transmitting a first set of data to a volatile memory via a shared memory bus. The method also includes transmitting a second set of data to a non-volatile memory via the shared memory bus concurrently with the transmitting of the first set of data.

In still other aspects of the present disclosure, a non-transitory computer-readable medium with program code recorded thereon is disclosed. The program code is executed by at least one processor and includes program code to transmit a first set of data to a volatile memory via a shared memory bus. The program code also includes program code to transmit a second set of data to a non-volatile memory via the shared memory bus concurrently with the transmitting of the first set of data.

Still other aspects of the present disclosure are directed to an apparatus. The apparatus includes means for transmitting a first set of data to a volatile memory via a shared memory bus. The apparatus also includes means for transmitting a second set of data to a non-volatile memory via the shared memory bus concurrently with the transmitting of the first set of data.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a system-on-a-chip (SoC), in accordance with various aspects of the present disclosure.

FIG. 2 illustrates an SoC in conventional communication with memory, in accordance with various aspects of the present disclosure.

FIG. 3A illustrates an SoC in communication with memory via a partially overlapping shared data bus, in accordance with various aspects of the present disclosure.

FIG. 3B illustrates an SoC in communication with memory via a fully overlapping shared data bus, in accordance with various aspects of the present disclosure.

FIG. 3C illustrates an SoC in communication with three memory components via a fully overlapping shared data bus, in accordance with various aspects of the present disclosure.

FIG. 3D illustrates an SoC in communication with four memory components via a fully overlapping shared data bus, in accordance with various aspects of the present disclosure.

FIG. 4 illustrates an SoC memory controller in communication with memory including mode registers, in accordance with various aspects of the present disclosure.

FIG. 5 illustrates an SoC memory controller in communication with memory via a non-overlapping shared data bus, in accordance with various aspects of the present disclosure.

FIG. 6 illustrates an SoC memory controller in communication with memory via a fully overlapping shared data bus, in accordance with various aspects of the present disclosure.

FIG. 7A illustrates an SoC memory controller in communication with two memory components via a shared clock line, in accordance with various aspects of the present disclosure.

FIG. 7B illustrates an SoC memory controller in communication with three memory components via a shared clock line, in accordance with various aspects of the present disclosure.

FIG. 8 is a flow diagram illustrating an example process performed, for example, by an SoC, in accordance with various aspects of the present disclosure.

FIG. 9 is a block diagram illustrating a design workstation used for circuit, layout, and logic design of components, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Several aspects of data transfer techniques will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

As described, the present disclosure relates to memory implementation. One type of memory often utilized by a system-on-a-chip (SoC) is NOR flash memory. A benefit of NOR flash memory is that the memory allows quick random access to any location in the memory array and 100% known good bits for the life of the hardware. This benefit makes NOR flash memory well-suited for applications specifying lower capacity and standby power, fast random read access, execute in place (XiP), and higher data reliability. The clock rate for NOR flash memory is also advantageous. For instance, NOR flash memory often supports clock rates up to 104 megahertz (MHz), while ordinary serial flash memory may be limited at 50 MHz. Because of these advantages, NOR flash memory may be used for code storage and execution.

NOR flash memory is generally divided into two varieties: parallel NOR memory and serial peripheral interface (SPI) NOR memory, or serial NOR memory. A distinction between SPI NOR memory and parallel NOR memory is that SPI flash devices specify fewer connections to a circuit board compared to parallel flash devices. Due to SPI NOR memory’s simpler interface, SPI NOR is less expensive to produce than parallel NOR storage devices. SPI NOR flash memory also comes with unique use-case advantages that make SPI NOR memory preferable for certain roles. For example, SPI NOR memory is often implemented to boot up an operating system.

Lightweight operating systems are especially suited for fitting within the limited capacity of NOR memory components, such as SPI NOR memory. NOR flash memory’s fast read performance enables the operating system to be booted far more quickly than would be possible if stored on other memory components, such as NAND memory. NOR flash memory is also well-suited for operating systems because operating systems tend to not be write-intensive. However, NOR flash memory’s poor write performance may cause slow operating system updates.

One technique to reduce disadvantages associated with SPI NOR flash memory is to add a buffer to the memory. The inclusion of a buffer enhances data transfer rates and improves overall device performance, however, the buffer also increases manufacturing costs. Consequently, the enhanced capabilities afforded by a buffer often result in a higher price point for end consumers. Another technique is to store device firmware in SPI NOR flash memory and then copy the firmware into synchronous dynamic random access memory (SDRAM) or static random-access memory (SRAM) when the device is powered on. However, copying the firmware is a slow and time-consuming process. Therefore, techniques are desired to reduce the disadvantages associated with NOR flash memory.

Various aspects of the present disclosure are directed to techniques for improved data transfer mechanisms. In some aspects, a shared data bus is coupled to a non-volatile memory via a non-volatile memory data bus. The non-volatile memory may be multi-bit flash memory such as NOR memory. The shared data bus is also coupled to a volatile memory via a volatile memory data bus. The volatile memory may be random access memory (RAM). The non-volatile memory data bus is a first subset of the shared data bus and the volatile memory data bus is a second subset of the shared data bus. For instance, the non-volatile memory data bus may overlap the volatile memory bus in the shared data bus. The shared data bus may also be coupled to a memory controller hosted by an SoC.

The volatile memory and the non-volatile memory each include a mode register that indicates a memory configuration. A memory controller may change how the volatile memory and non-volatile memory perform memory operations by updating the mode registers to indicate a different configuration state. For instance, in one configuration state, the volatile memory and non-volatile memory may be in direct communication with each other via the shared data bus. The memory controller may change the value stored by the mode registers by transmitting a configuration command to the volatile and non-volatile memory. The volatile and non-volatile memory may then transition to a different configuration state, such as a configuration state where the volatile memory and non-volatile memory communicate with the memory controller via a shared address space.

Particular aspects of the subject matter described in this disclosure can be implemented to realize one or more of the following potential advantages. In some examples, the described techniques and components, such as the shared data bus and mode registers, enable fast data transfer between NOR flash memory, low-power double-date rate (LPDDR) memory, NAND flash memory (such as universal flash storage and non-volatile memory express memory), and an application processor. The fast data transfer may benefit artificial intelligence applications. Other advantages include improved system reliability and safety in auto applications, less power consumption, and a reduction in total specified pins for data buses.

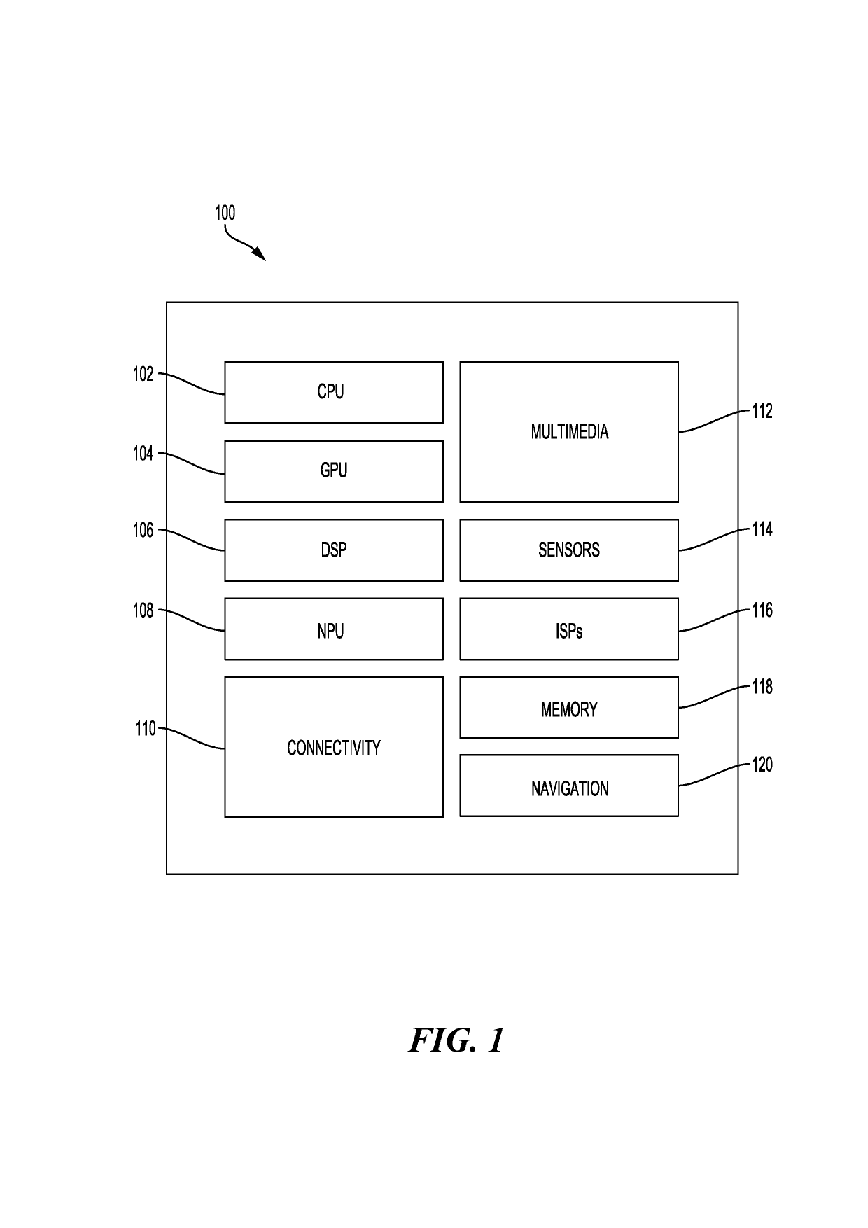

FIG. 1 illustrates an example implementation of a system-on-a-chip (SoC) 100, which may include a central processing unit (CPU) 102 or a multi-core CPU configured for memory operations. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SoC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SoC 100 may also include a sensor processor 114, image signal processors (ISPs) 116, and/or navigation module 120, which may include a global positioning system.

The SoC 100 may be based on an ARM, RISC-V (RISC-five), or any reduced instruction set computing (RISC) architecture. In aspects of the present disclosure, the instructions loaded into the CPU 102 may include code to transmit a first set of data to a volatile memory via a shared memory bus. The instructions loaded into the CPU 102 may also include code to transmit a second set of data to a non-volatile memory via the shared memory bus concurrently with the transmitting of the first set of data.

According to aspects of the present disclosure, an apparatus includes an SoC memory controller. The apparatus may include means for transmitting. For example, the means for transmitting may be any of the CPU 102, GPU 104, DSP 106, NPU 108, connectivity block 110, ISPs 116, memory block 118, SoC 360, first parallel NOR flash memory 362, second parallel NOR flash memory 364, first LPDDR memory 366, second LPDDR memory 368, shared data bus 370, first data bus 372, second data bus 374, third data bus 376, fourth data bus 378, fifth data bus 380, SoC memory controller 400, and shared clock bus 718.

As described, the present disclosure relates to memory implementation. One type of memory utilized by an SoC, such as the SoC 100 described with respect to FIG. 1, is NOR flash memory. NOR flash memory is organized into sectors and pages. A sector is the smallest erasable block size and can be divided into pages. Sectors are usually measured in kilobytes (KB). Pages, however, can be individually written to or read from. Page sizes are measured in bytes, such as 256 bytes or 512 bytes.

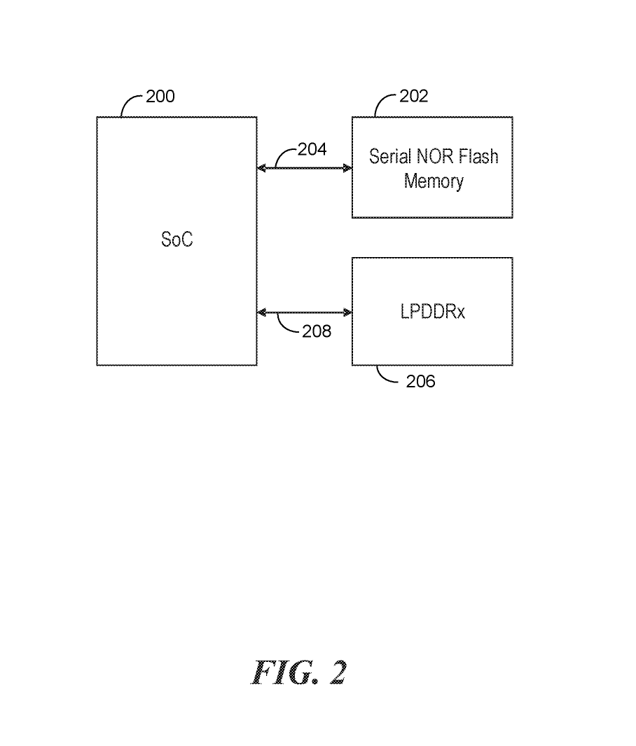

FIG. 2 illustrates an SoC in conventional communication with memory, in accordance with various aspects of the present disclosure. As shown in FIG. 2, an SoC 200 is coupled to serial NOR flash memory 202 via a first data bus 204. The SoC 200 is also coupled to low-power double-date rate (LPDDR) memory 206 via a second data bus 208. The “x” appended to the “LPDDR” in FIG. 2 indicates that the LPDDR memory 206 may be any version of LPDDR memory.

As discussed, one advantage of serial NOR flash memory, such as the serial NOR flash memory 202, is that serial NOR flash memory overcomes the disadvantage of the higher signal count associated with parallel flash memory. The serial interface has significantly fewer signals, allowing a smaller device package and easier printed circuit board (PCB) routing. One downside of serial NOR flash memory is that serial NOR flash memory sacrifices an advantage of parallel NOR flash memory, direct random memory access.

In one configuration, the serial NOR flash memory 202 implements the SPI protocol to interface with a memory controller integrated with the SoC 200. This configuration fails to achieve data transfer rates specified for many applications. For example, automobile functional safety applications specify a bootup time between ten and fifteen milliseconds (ms). Operating at 100 MHz single data rate (SDR), the serial NOR flash memory 202 may take ten nanoseconds (ns) to transfer a single bit of data. Transferring 32 KB of data may therefore take two to the power of 15 ns, or 328 microseconds (ms). Larger data transfers, such as data transfers exceeding one megabyte (MB), consistently exceed the specified bootup time of functional safety applications. Because the serial NOR flash memory 202 and LPDDR memory 206 may only communicate by transferring data through the SoC 200, data transfers between the serial NOR flash memory 202 and LPDDR memory 206 may be too slow for many applications.

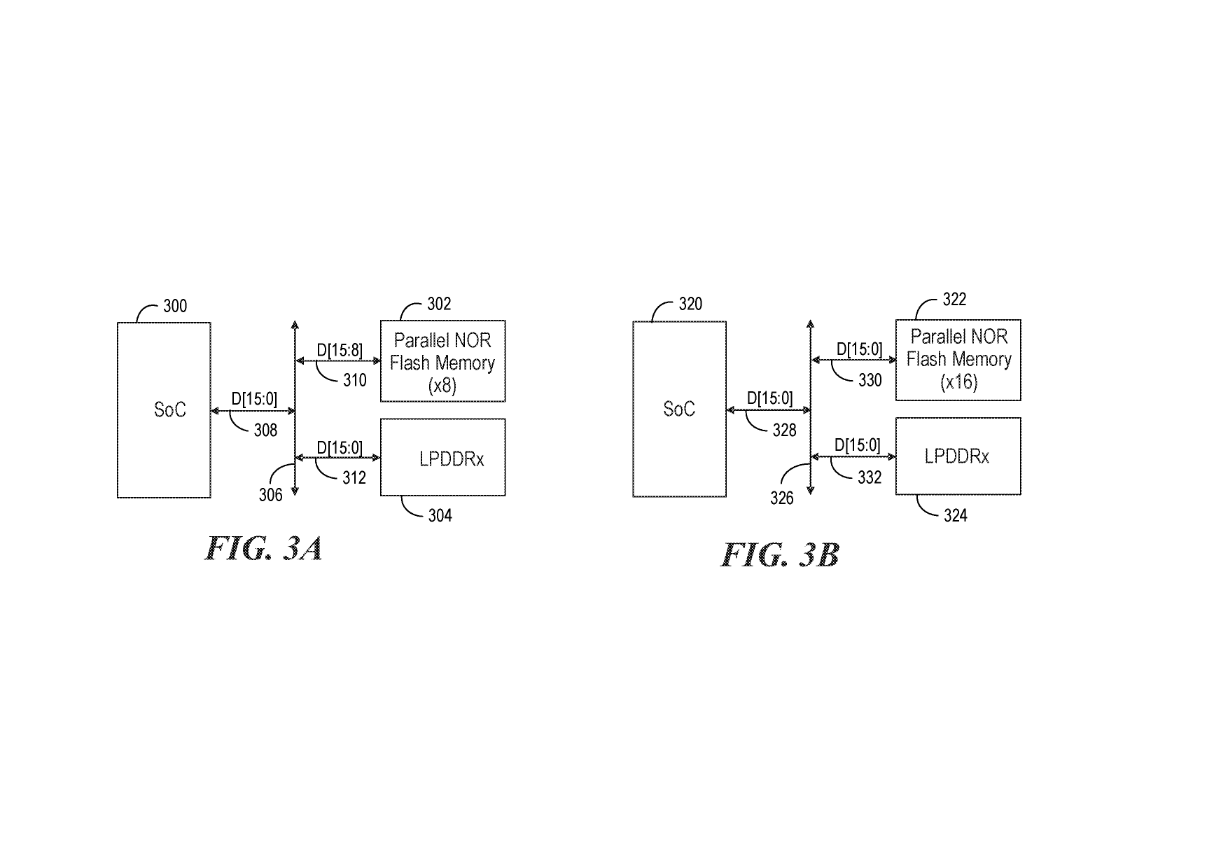

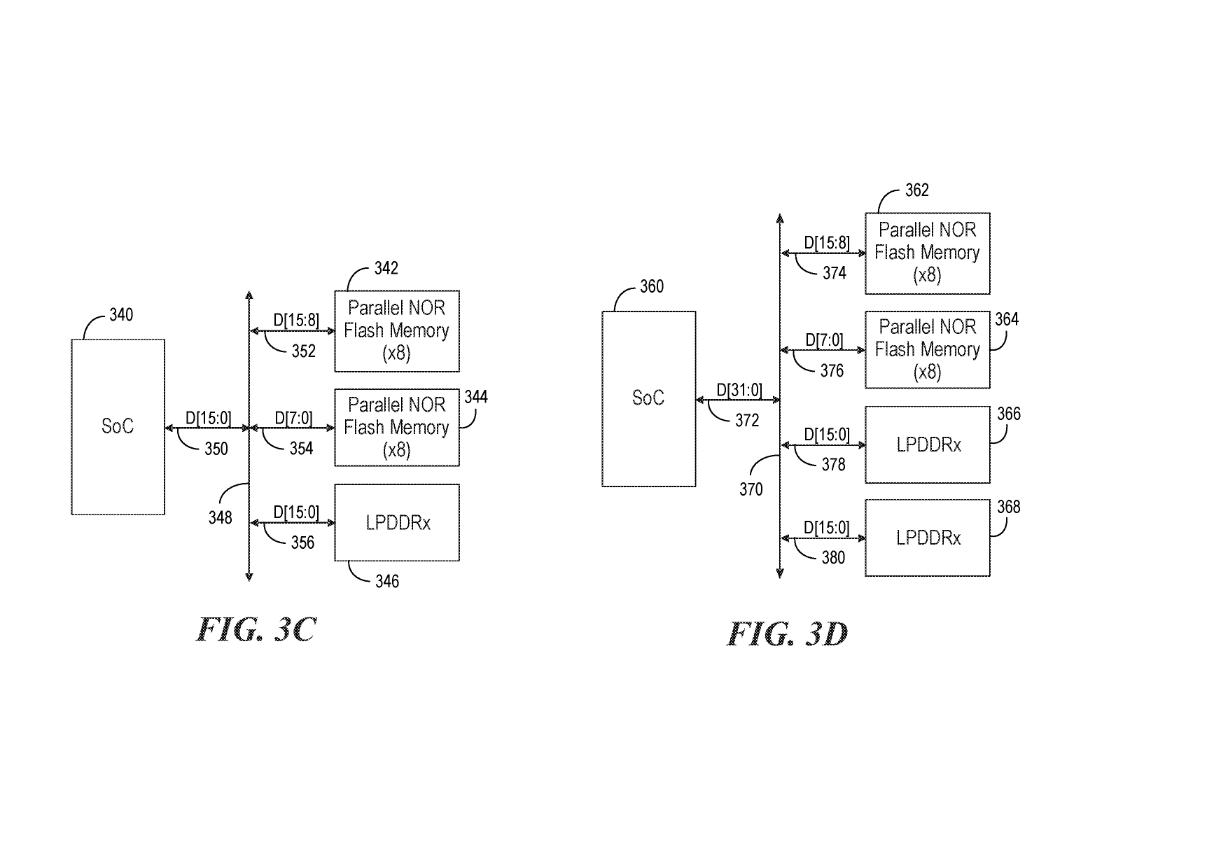

FIG. 3A illustrates an SoC in communication with memory via a partially overlapping shared data bus, in accordance with various aspects of the present disclosure. As shown in FIG. 3A, an SoC 300 is in communication with eight-bit parallel NOR flash memory 302 and LPDDR memory 304. A shared data bus 306 is coupled to the SoC 300 via a first data bus 308. The shared data bus 306 is also coupled to the parallel NOR flash memory 302 via a second data bus 310. Additionally, the shared data bus 306 is coupled to the LPDDR memory 304 via a third data bus 312.

Because the parallel NOR flash memory 302 and the LPDDR memory 304 share the same data bus 306, the parallel NOR flash memory 302 and the LPDDR memory 304 may operate concurrently. For example, if the shared data bus 306 is a sixteen-bit data bus, the LPDDR memory 304 may be connected to all sixteen bits (bits 15:0) via the third data bus 312 and the parallel NOR flash memory 302 may be connected to only the last eight bits (bits 15:8) via the second data bus 310. In this example, the shared data bus 306 partially overlaps the bits of the second data bus 310 and third data bus 312. In another example, the third data bus 312 may be connected to only the first eight bits (bits 7:0) of the shared data bus 306 for accessing mode registers and the second data bus 310 may be connected to only the second eight bits (bits 15:8) of the shared data bus 306 for data transfers. The first data bus 308 may be connected to all sixteen bits (bits 15:0) for sending or receiving date from the parallel NOR flash memory 302 and/or the LPDDR memory 304. Other configurations are possible.

The example illustrated with respect to FIG. 3A offers several advantages. For instance, data transfers between the LPDDR memory 304 and the parallel NOR flash memory 302 may occur without looping through the SoC 300. As another advantage, the LPDDR memory 304 may be used as a buffer by the parallel NOR flash memory 302 or other NOR flash memory. In memory operations, the LPDDR memory 304 may implement the parallel NOR flash memory 302, or the parallel NOR flash memory 302 may implement the LPDDR memory 304. For instance, the parallel NOR flash memory 302 may use the LPDDR memory 304 as a data buffer to expedite NOR flash updates.

Because the parallel NOR flash memory 302 and LPDDR memory 304 share the shared data bus 306, the parallel NOR flash memory 302 and the LPDDR memory 304 may execute in parallel. Parallel execution of the parallel NOR flash memory 302 and the LPDDR memory 304 may enable a faster bootup process by reallocating code conventionally in NAND flash memory to NOR flash memory. In one example, an eight-bit parallel NOR flash memory implementing a shared data bus, such as the shared data bus 306, may operate at 200 MHz DDR. In this example, the parallel NOR flash memory may take only five ns to transfer sixteen bits of data. Therefore, to transfer thirty-two kilobytes of data, the parallel NOR flash memory may only take 10.24 ms, which is significantly faster than the 328 ms taken by the serial NOR flash memory 202 illustrated with respect to FIG. 2. The examples illustrated with respect to FIGS. 3B, 3C, 4, 5, 6, and 7 may implement the same or similar techniques to produce the same or similar advantages for data transfer.

The configuration illustrated with respect to FIG. 3A shows the LPDDR memory 304 connected to all sixteen bits of the shared data bus 306, while the parallel NOR flash memory 302 is connected to only the last eight bits of the shared data bus 306. In practice, however, the LPDDR memory 304 may only use the first eight bits of the shared data bus 306, despite being connected to all sixteen bits. Because the LPDDR memory 304 may only use the first eight bits of the shared data bus 306, the LPDDR memory 304 may therefore avoid data collision with the parallel NOR flash memory 302 if both devices simultaneously transfer data over the shared data bus 306.

FIG. 3B illustrates an SoC in communication with memory via a fully overlapping shared data bus, in accordance with various aspects of the present disclosure. As shown in FIG. 3B, an SoC 320 is in communication with sixteen-bit parallel NOR flash memory 322 and LPDDR memory 324. A shared data bus 326 is coupled to the SoC 320 via a first data bus 328. The shared data bus 326 is also coupled to the parallel NOR flash memory 322 via a second data bus 330. Additionally, the shared data bus 326 is coupled to the LPDDR memory 324 via a third data bus 332.

The example illustrated with respect to FIG. 3B is similar to the example illustrated with respect to FIG. 3A. One difference is that the second data bus 330 of FIG. 3B is connected to all sixteen bits of the shared data bus 326. Both the second data bus 330 and the third data bus 332 are connected to all sixteen bits of the shared data bus 326. Therefore, the second data bus 330 and the third data bus 332 are fully overlapping at the shared data bus 326.

The SoC 320 may avoid data collision between the parallel NOR flash memory 322 and the LPDDR memory 324 by, for example, implementing a unified addressing space. In this example, the parallel NOR flash memory 322 may occupy a first portion of the addressing space and the LPDDR memory 324 may occupy a second portion of the addressing space. The SoC 320 may then communicate with either the parallel NOR flash memory 322 or the LPDDR memory 324 by using an address that is unique to one of the parallel NOR flash memory 322 or the LPDDR memory 324.

FIG. 3C illustrates an SoC in communication with three memory components via a fully overlapping shared data bus, in accordance with various aspects of the present disclosure. As shown in FIG. 3C, an SoC 340 is in communication with a first parallel NOR flash memory 342, a second parallel NOR flash memory 344, and LPDDR memory 346. Both the first parallel NOR flash memory 342 and the second parallel NOR flash memory 344 are eight-bit. The SoC 340 is connected to a shared data bus 348 via a first data bus 350. The first parallel NOR flash memory 342 is connected to the shared data bus 348 via a second data bus 352. The second parallel NOR flash memory 344 is connected to the shared data bus 348 via a third data bus 354. Additionally, the LPDDR memory 346 is connected to the shared data bus 348 via a fourth data bus 356.

FIG. 3C is similar to FIGS. 3A and 3B, except that FIG. 3C illustrates two parallel NOR flash memory components. The second data bus 352 connects the first parallel NOR flash memory 342 to the last eight bits (bits 15:8) of the shared data bus 348. The third data bus 354 connects the second parallel NOR flash memory 344 to the first eight bits (bits 7:0) of the shared data bus 348. The fourth data bus 356 connects the LPDDR memory 346 to all sixteen bits (bits 15:0) of the shared data bus 348. In the configuration shown in FIG. 3C, the LPDDR memory 346 receives data input and produces data output on the shared data bus 348 via the fourth data bus 356. At the shared data bus 348, the data lanes allocated to the LPDDR memory 346 may overlap with the second parallel NOR flash memory data lanes on the first eight bits. Additionally, the data lanes allocated to the LPDDR memory 346 may overlap with the first parallel NOR flash memory data lanes on the last eight bits.

Still other implementations are contemplated. For example, the shared data bus 348 may include any combination of data lanes from the second data bus 352, third data bus 354, and/or fourth data bus 356. In another example, each of the second data bus 352, third data bus 354, and fourth data bus 356 shares the same data lanes of the shared data bus 348, such that one of the first parallel NOR flash memory 342, second parallel NOR flash memory 344, and LPDDR memory 346 may transmit or receive data on the shared data bus 348 at one time. In still another example, the second data bus 352 shares data lanes of the shared data bus 348 with the fourth data bus 356. In another example, the third data bus 354 shares data lanes with of the shared data bus 348 with the fourth data bus 356.

FIG. 3D illustrates an SoC in communication with four memory components via a fully overlapping shared data bus, in accordance with various aspects of the present disclosure. As shown in FIG. 3D, an SoC 360 is in communication with a first parallel NOR flash memory 362, a second parallel NOR flash memory 364, a first LPDDR memory 366, and a second LPDDR memory 368. Both the first parallel NOR flash memory 362 and the second parallel NOR flash memory 364 are eight-bit. The SoC 360 is connected to a shared data bus 370 via a first data bus 372. The first parallel NOR flash memory 362 is connected to the shared data bus 370 via a second data bus 374. The second parallel NOR flash memory 364 is connected to the shared data bus 370 via a third data bus 376. Additionally, the first LPDDR memory 366 is connected to the shared data bus 370 via a fourth data bus 378. Further, the second LPDDR memory 368 is connected to the shared data bus 370 via a fifth data bus 380.

As shown in FIG. 3D, the SoC is in communication with two LPDDR channels via the shared data bus 370. For example, a channel may include the first LPDDR memory 366 and the fourth data bus 378. Each channel may implement a data bus having a quantity of lanes. For instance, the fourth data bus 378 may be a 16-bit data bus having sixteen lanes or 32-bit data bus having thirty-two lanes (not shown). The fifth data bus 380 may be a 16-bit data bus having sixteen lanes or a 32-bit data bus having thirty-two lanes (not shown). In FIG. 3D, an LPDDR channel and a NOR flash channel may be active in parallel. For example, both the first LPDDR memory 366 and the first parallel NOR flash memory 362 may send or receive data via the shared data bus 370 at one time.

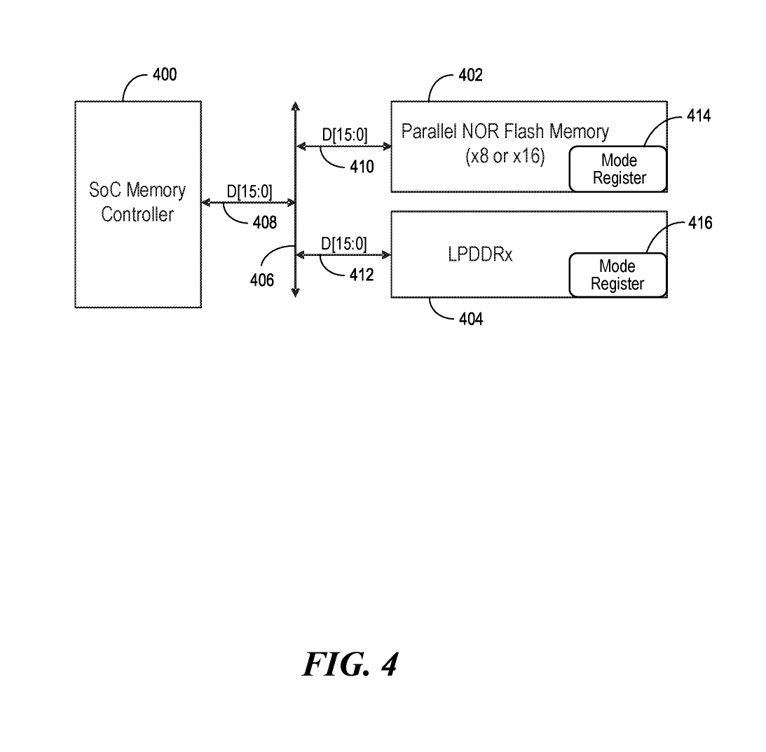

FIG. 4 illustrates an SoC memory controller in communication with memory including mode registers, in accordance with various aspects of the present disclosure. The SoC memory controller 400 may control and configure flash and LPDDR memory operation. As shown in FIG. 4, the SoC memory controller 400 is in communication with parallel NOR flash memory 402 and LPDDR memory 404. The parallel NOR flash memory 402 may support an eight-bit data path or a sixteen-bit data path. A shared data bus 406 is coupled to the SoC memory controller 400 via a first data bus 408. The shared data bus 406 is also coupled to the parallel NOR flash memory 402 via a second data bus 410. Additionally, the shared data bus 406 is coupled to the LPDDR memory 404 via a third data bus 412.

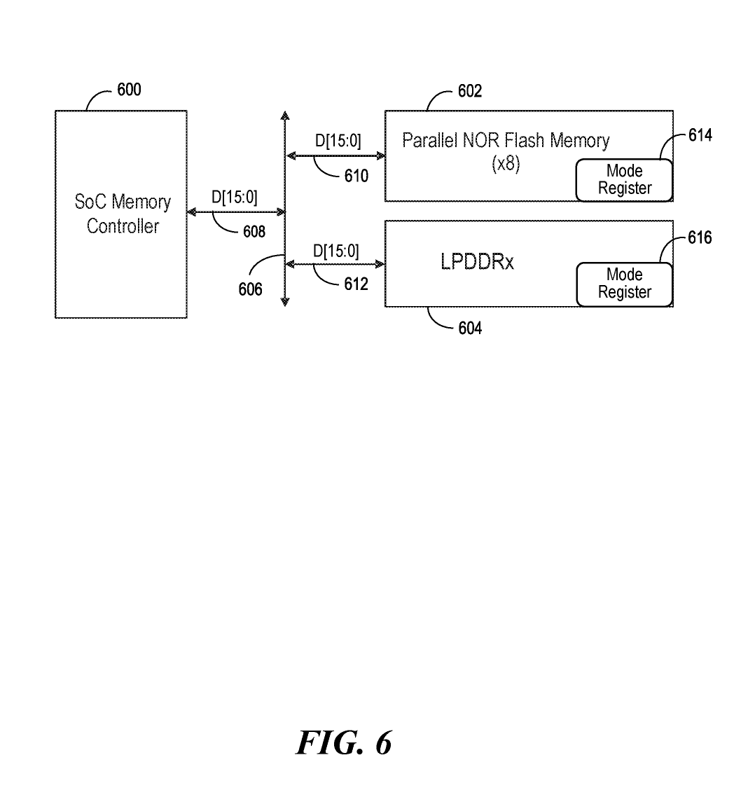

As discussed, aspects of the present disclosure include multiple data transfer configurations, such as the configurations illustrated with respect to FIGS. 3A, 3B, and 3C. The parallel NOR flash memory 402 includes a first mode register 414, and the LPDDR memory 404 includes a second mode register 416. The SoC memory controller 400 may change between data transfer configurations by changing the value stored by mode registers stored in memory devices, such as the first mode register 414 and the second mode register 416. Changing between data transfer configurations is discussed further with respect to FIG. 6.

In the configuration shown in FIG. 4, the second data bus 410 fully overlaps the third data bus 412 on all sixteen bits of the shared data bus 406. To prevent data collisions during memory operations, the SoC memory controller 400 may implement uniform addressing techniques. For example, the parallel NOR flash memory 402 and the LPDDR memory 404 may share an address space. The LPDDR memory 404 may occupy a lower portion of the address space while the parallel NOR flash memory 402 may occupy an upper portion of the address space. The SoC memory controller 400 may then access either the parallel NOR flash memory 402 or the LPDDR memory 404 by using an address that is unique to the parallel NOR flash memory 402 or the LPDDR memory 404. In some implementations, only one of the parallel NOR flash memory 402 or the LPDDR memory 404 may be active at one time in order to prevent data collision on the shared data bus 406.

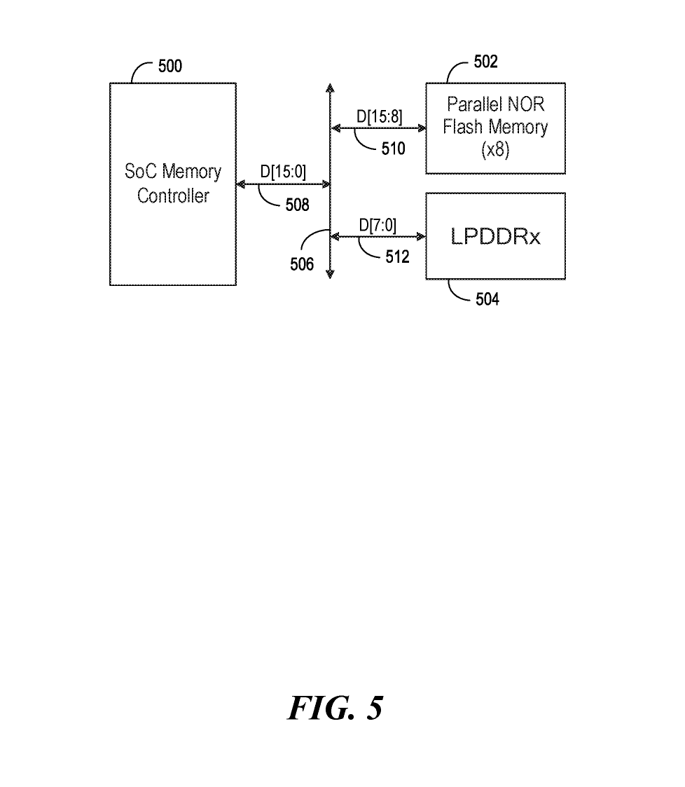

FIG. 5 illustrates an SoC memory controller in communication with memory via a non-overlapping shared data bus, in accordance with various aspects of the present disclosure. As shown in FIG. 5, an SoC memory controller 500 is in communication with eight-bit parallel NOR flash memory 502 and LPDDR memory 504. A shared data bus 506 is coupled to the SoC memory controller 500 via a first data bus 508. The shared data bus 506 is also coupled to the parallel NOR flash memory 502 via a second data bus 510. Additionally, the shared data bus 506 is coupled to the LPDDR memory 404 via a third data bus 512.

Because the parallel NOR flash memory 502 and the LPDDR memory 504 share the same data bus with no overlap, the parallel NOR flash memory 502 and the LPDDR memory 504 may operate simultaneously. For example, the LPDDR memory 504 may be connected to the first eight bits (bits 7:0) of the shared data bus 506 via the third data bus 512, and the parallel NOR flash memory 502 may be connected to only the last eight bits (bits 15:8) of the shared data bus 506 via the second data bus 510. In this example, the shared data bus 506 does not overlap between the bits of the second data bus 510 and third data bus 512. In the configuration illustrated with respect to FIG. 5, the SoC memory controller 500 may access both the parallel NOR flash memory 502 and the LPDDR memory 504 simultaneously. Because the second data bus 510 and the third data bus 512 use different bus lines, there is no risk of data collision if the parallel NOR flash memory 502 and the LPDDR memory 504 operate simultaneously.

FIG. 6 illustrates an SoC memory controller in communication with memory via a fully overlapping shared data bus, in accordance with various aspects of the present disclosure. As shown in FIG. 6, an SoC memory controller 600 is in communication with eight-bit parallel NOR flash memory 602 and LPDDR memory 604. A shared data bus 606 is coupled to the SoC memory controller 600 via a first data bus 608. The shared data bus 606 is also coupled to the parallel NOR flash memory 602 via a second data bus 610. Additionally, the shared data bus 606 is coupled to the LPDDR memory 604 via a third data bus 612. The parallel NOR flash memory 602 includes a first mode register 614, and the LPDDR memory 604 includes a second mode register 616.

Aspects of the present disclosure include multiple data transfer configurations, such as the configurations illustrated with respect to FIGS. 3A, 3B, and 3C, 4, and 5. During operation, one configuration may become preferable over another configuration. For example, some memory operations may be better suited to the fully overlapping configuration illustrated with respect to FIG. 4, rather than the non-overlapping configuration illustrated with respect to FIG. 5.

During operation, the SoC memory controller 600 may change configurations by signaling the first mode register 614 and/or the second mode register 616 via a configuration command. For example, the SoC memory controller 600 may issue a configuration command to set both the first mode register 614 and second mode register 616 to zero. A stored value of zero in both the first mode register 614 and second mode register 616 may indicate a first configuration, while different stored values may indicate different configurations.

In one configuration, the SoC memory controller 600 allocates different data lanes of the shared data bus 606 to the parallel NOR flash memory 602 and the LPDDR memory 604. For instance, the lower eight-bit data lanes may be allocated to the LPDDR memory 604 and the upper eight-bit data lanes may be allocated to the parallel NOR flash memory 602. In another configuration, the parallel NOR flash memory 602 and the LPDDR memory 604 may transfer data directly to each other, without looping data through a host device. Some configurations may specify a shared address space between the parallel NOR flash memory 602 and the LPDDR memory 604, while other configurations may specify different address spaces.

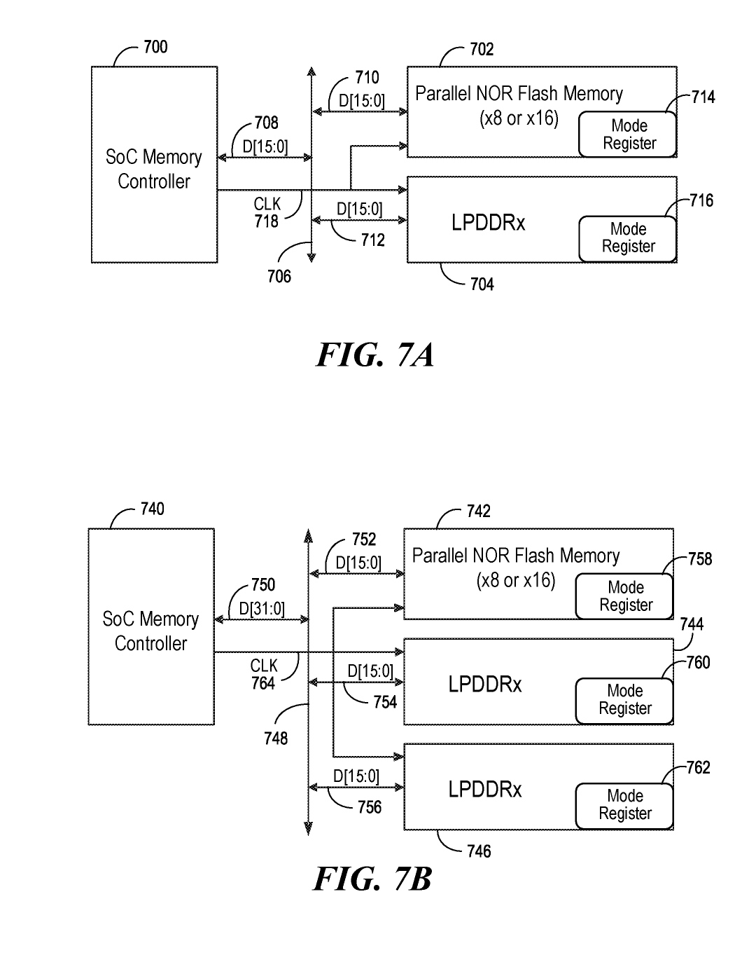

FIG. 7A illustrates an SoC memory controller in communication with two memory components via a shared clock line, in accordance with various aspects of the present disclosure. As shown in FIG. 7A, an SoC memory controller 700 is in communication with parallel NOR flash memory 702 and LPDDR memory 704. The parallel NOR flash memory 702 may support an eight-bit data path or a sixteen-bit data path. A shared data bus 706 is coupled to the SoC memory controller 700 via a first data bus 708. The shared data bus 706 is also coupled to the parallel NOR flash memory 702 via a second data bus 710. Additionally, the shared data bus 706 is coupled to the LPDDR memory 704 via a third data bus 712. The parallel NOR flash memory 702 includes a first mode register 714 and the LPDDR memory 704 includes a second mode register 716.

FIG. 7A also illustrates a shared clock bus 718. The shared clock bus 718 provides clock signals from a host, such as an SoC or the SoC memory controller 700, to the parallel NOR flash memory 702 and the LPDDR memory 704. In some configurations, such as a configuration enabling direct data transfer between the parallel NOR flash memory 702 and the LPDDR memory 704, the host may enter into a hibernation state or power saving mode while still providing a clock signal to both the parallel NOR flash memory 702 and the LPDDR memory 704. For instance, the host’s data port may be in a tri-state or may be undriven while the host enables synchronous data transfer between the parallel NOR flash memory 702 and the LPDDR memory 704 by providing clock data via the shared clock bus 718.

In some implementations (not shown), separate clock lines may connect the host to the parallel NOR flash memory 702 and the LPDDR memory 704. The separate clock lines may enable the LPDDR memory 704 to operate at multiple frequencies so that the LPDDR memory 704 is not limited by the frequencies employed by the parallel NOR flash memory 702. Additionally, separate clock lines may enable synchronous and asynchronous data operations with respect to the parallel NOR flash memory 702 and the LPDDR memory 704. Asynchronous operation may be enabled with each memory 702, 704 having its own separate clock source.

The varying configurations illustrated and described with respect to this disclosure may also include separate control buses between the host and memory, such as the parallel NOR flash memory 702 and the LPDDR memory 704. Each control bus may be implemented, for example, to transfer a command signal. Although the data buses illustrated and described with respect to this disclosure are sixteen-bit data buses, varying sizes are contemplated. For example, the shared data bus 706 may be a thirty-two-bit data bus.

As discussed, the second data bus 710 and the third data bus 712 may each be a subset of the shared data bus 706. In some implementations, the second data bus 710 and the third data bus 712 may each be the same subset of the shared data bus 706. For example, the second data bus 710 and the third data bus 712 may share the same data lines in the shared data bus 706. In other implementations, the second data bus 710 may be a subset of the third data bus 712, or the third data bus 712 may be a subset of the second data bus 710. For instance, the second data bus 710 may only use data lines of the shared data bus 706 that are also used by the third data bus 712, while the third data bus 712 uses additional data lines that are not used by the second data bus 710. In still further implementations, the second data bus 710, third data bus 712, and/or the shared data bus 706 may each share the same data lines, such that the first subset and/or the second subset are the same as the shared data bus 706.

An example will now be presented. In this example, a shared data bus is coupled to a non-volatile memory via a non-volatile memory data bus. The non-volatile memory may be multi-bit flash memory, and may be referred to as parallel flash memory. The shared data bus is also coupled to a volatile memory via a volatile memory data bus. The volatile memory may be random access memory (RAM). The non-volatile memory data bus is a first subset of the shared data bus and the volatile memory data bus is a second subset of the shared data bus. For instance, the non-volatile memory data bus may overlap the volatile memory bus in the shared data bus, such as in the configuration illustrated and described with respect to FIG. 6. The shared data bus may also be coupled to a memory controller.

The non-volatile memory and the volatile memory may include mode registers, where each mode register indicates a configurations state. The memory controller may use a configuration command to toggle the mode registers between configuration states. Each configuration state may affect the manner in which the volatile memory, non-volatile memory, memory controller and data buses couple through various configurations. For example, in one configuration state, the non-volatile memory and the volatile memory share an address space. In this example, the non-volatile memory may be associated with a first part of the address space and the volatile memory may be associated with a second part of the address space. In another configuration state, the memory controller may allocate a first portion of a set of data lines included in the shared memory bus to the non-volatile memory and another portion of the set of data lines to the volatile memory. Still another configuration state may enable direct data transfer between the non-volatile memory and the volatile memory via the shared data bus.

FIG. 7B illustrates an SoC memory controller in communication with three memory components via a shared clock line, in accordance with various aspects of the present disclosure. As shown in FIG. 7B, an SoC memory controller 740 is in communication with parallel NOR flash memory 742, a first LPDDR memory 744, and a second LPDDR memory 746. The parallel NOR flash memory 742 may support an eight-bit data path or a sixteen-bit data path. A shared data bus 748 is coupled to the SoC memory controller 740 via a first data bus 750. The shared data bus 748 is also coupled to the parallel NOR flash memory 742 via a second data bus 752. Additionally, the shared data bus 748 is coupled to the first LPDDR memory 744 via a third data bus 754. The shared data bus 748 is also coupled to the second LPDDR memory 746 via a fourth data bus 756. The parallel NOR flash memory 742 includes a first mode register 758, the first LPDDR memory 744 includes a second mode register 760, and the second LPDDR memory 746 includes a third mode register 762. FIG. 7B also illustrates a shared clock bus 764. The shared clock bus 764 provides clock signals from a host, such as an SoC or the SoC memory controller 740, to the parallel NOR flash memory 742, the first LPDDR memory 744, and the second LPDDR memory 746.

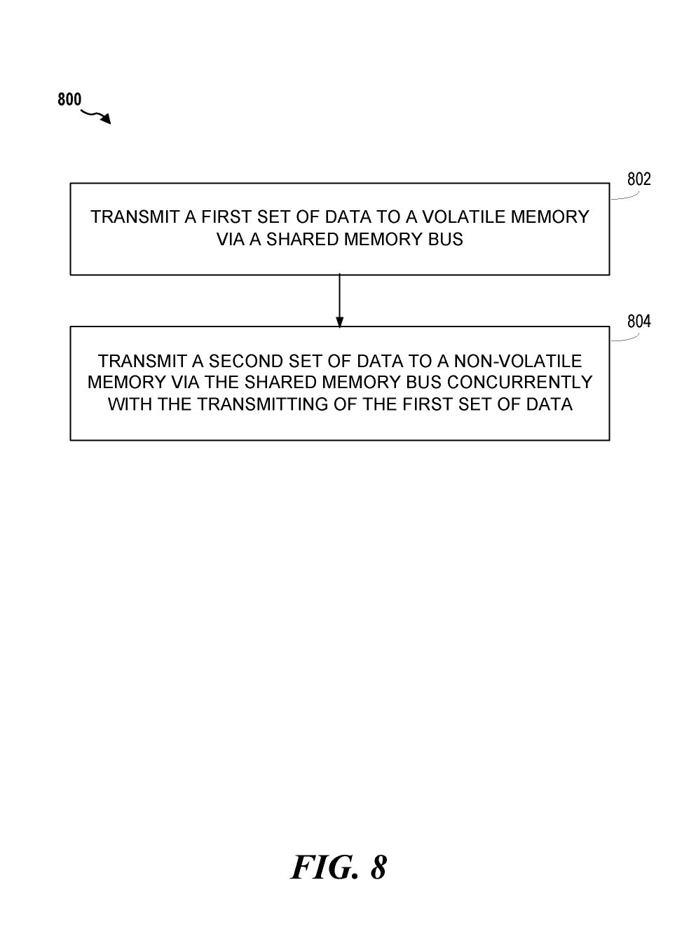

FIG. 8 is a flow diagram illustrating an example process 800 performed, for example, by an SoC, in accordance with various aspects of the present disclosure. In some aspects, the process 800 may include transmitting a first set of data to a volatile memory via a shared memory bus (block 802). The volatile memory may be, for example, double-data rate (DDR) memory. In some implementations, the volatile memory may include a group of memory components, each memory component hosting a mode register. For example, an SoC may concurrently transmit data to a first LPDDR memory component and a second LPDDR memory component.

The process 800 may also include transmitting a second set of data to a non-volatile memory via the shared memory bus concurrently with the transmitting of the first set of data (block 804). Concurrently transmitting the data may be based on a configuration state indicated by a mode register hosted by the volatile memory or non-volatile memory. For example, one configuration state may include a shared address space, where transmitting to the non-volatile memory is via a first part of the shared address space and transmitting to the volatile memory is via a second part of the shared address space. Another configuration state may specify separate data lanes at the shared memory bus. For example, the configuration state may specify transmitting to the non-volatile memory via a first set of data lanes of the shared memory bus and transmitting to the volatile memory via a second set of data lanes of the shared memory bus, the first set of data lanes being different than the second set of data lanes.

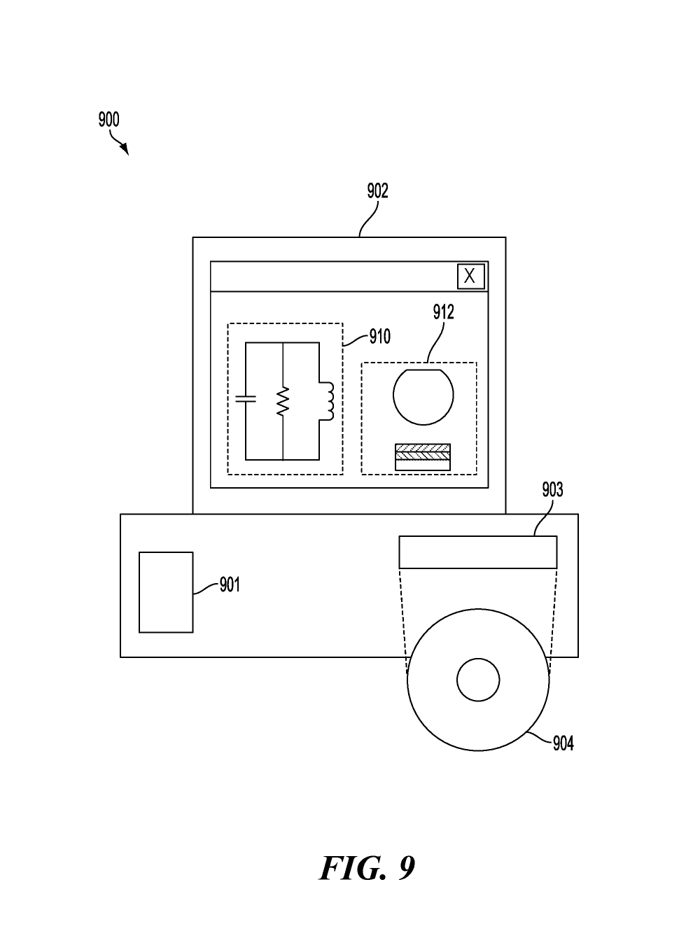

FIG. 9 is a block diagram illustrating a design workstation 900 used for circuit, layout, and logic design of a semiconductor component, such as the shared data bus, disclosed above. The design workstation 900 includes a hard disk 901 containing operating system software, support files, and design software such as Cadence or OrCAD. The design workstation 900 also includes a display 902 to facilitate design of a circuit 910 or a semiconductor component 912, such as the mode registers. A storage medium 904 is provided for tangibly storing the design of the circuit 910 or the semiconductor component 912 (e.g., the shared data bus and mode registers). The design of the circuit 910 or the semiconductor component 912 may be stored on the storage medium 904 in a file format such as GDSII or GERBER. The storage medium 904 may be a CD-ROM, DVD, hard disk, flash memory, or other appropriate device. Furthermore, the design workstation 900 includes a drive apparatus 903 for accepting input from or writing output to the storage medium 904.

Data recorded on the storage medium 904 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 904 facilitates the design of the circuit 910 or the semiconductor component 912 by decreasing the number of processes for designing semiconductor wafers.

Example Aspects

Aspect 1: An apparatus, comprising: a shared data bus coupled to a non-volatile memory via a non-volatile memory data bus, and coupled to a volatile memory via a volatile memory data bus, the non-volatile memory data bus is a first subset of the shared data bus and the volatile memory data bus is a second subset of the shared data bus; and a memory controller coupled to the shared data bus and both the non-volatile memory and the volatile memory via the shared data bus.

Aspect 2: The apparatus of Aspect 1, in which the non-volatile memory is multi-bit flash memory and the volatile memory is random access memory (RAM).

Aspect 3: The apparatus of Aspect 1 or 2, in which the non-volatile memory bus overlaps the volatile memory data bus in the shared data bus.

Aspect 4: The apparatus of any of the Aspects 1-3, further comprising a volatile memory control bus coupled to the volatile memory and a non-volatile memory control bus coupled to the non-volatile memory, the volatile memory control bus not shared with the non-volatile memory control bus.

Aspect 5: The apparatus of any of the Aspects 1-4, in which the non-volatile memory and the volatile memory share an address space, the non-volatile memory associated with a first portion of the address space and the volatile memory associated with a second portion of the address space.

Aspect 6: The apparatus of any of the Aspects 1-5, in which: the shared data bus includes a set of data lanes; the memory controller allocates a first portion of the set of data lanes to the non-volatile memory; and the memory controller allocates a second portion of the set of data lanes to the volatile memory.

Aspect 7: The apparatus of any of the Aspects 1-6, in which: the non-volatile memory includes a first mode register; the volatile memory includes a second mode register; the first mode register and the second mode register each indicate one of a plurality of configuration states; the memory controller is configured to toggle, via a configuration command, the first mode register and the second mode register between the plurality of configuration states; and the memory controller, the volatile memory, and the non-volatile memory are configured to couple based on the configuration state indicated by the first mode register and the second mode register.

Aspect 8: The apparatus of any of the Aspects 1-7, in which: in a first configuration state of the plurality of configuration states, the non-volatile memory and the volatile memory share an address space, the non-volatile memory associated with a first part of the address space and the volatile memory associated with a second part of the address space; and in a second configuration state of the plurality of configuration states: the shared data bus includes a set of data lanes; the memory controller allocates a first portion of the set of data lanes to the non-volatile memory; and the memory controller allocates a second portion of the set of data lanes to the volatile memory.

Aspect 9: The apparatus of any of the Aspects 1-8, in which the first mode register and the second mode register indicate a third configuration state, the third configuration state enabling direct data transfer between the non-volatile memory and the volatile memory via the shared data bus.

Aspect 10: The apparatus of any of the Aspects 1-9, further comprising a clock line coupling a host to the non-volatile memory and the volatile memory, the clock line providing clock data to the non-volatile memory and the volatile memory, while the host is in a power saving mode and synchronous direct data transfer is occurring between the non-volatile memory and the volatile memory via the shared data bus.

Aspect 11: The apparatus of any of the Aspects 1-10, in which the volatile memory includes a plurality of volatile memory components, each volatile memory component coupled to the shared data bus via a respective volatile memory bus.

Aspect 12: The apparatus of any of the Aspects 1-11, in which each volatile memory component of the plurality of volatile memory components is random access memory (RAM) and includes a mode register.

Aspect 13: A method, comprising: transmitting a first set of data to a volatile memory via a shared memory bus; and transmitting a second set of data to a non-volatile memory via the shared memory bus concurrently with the transmitting of the first set of data.

Aspect 14: The method of Aspect 13, in which transmitting to the non-volatile memory is via a first part of a shared address space and transmitting to the volatile memory is via a second part of the shared address space.

Aspect 15: The method of Aspect 13, in which transmitting to the non-volatile memory is via a first set of data lanes of the shared memory bus and transmitting to the volatile memory is via a second set of data lanes of the shared memory bus, the first set of data lanes being different than the second set of data lanes.

Aspect 16: The method of Aspect 13 or 15, in which the transmitting the second set of data to the non-volatile memory occurs simultaneously with the transmitting of the first set of data.

Aspect 17: The method of any of the Aspects 13-16, further comprising transmitting a configuration command to a mode register hosted by one of the volatile memory or the non-volatile memory, the configuration command indicating a transmission technique to transmit and receive a third set of data via the shared memory bus.

Aspect 18: The method of any of the Aspects 13-17, further comprising transmitting, from one of the volatile memory or the non-volatile memory, a fourth set of data directly to the other of the volatile memory or the non-volatile memory, via the shared memory bus.

Aspect 19: The method of any of the Aspects 13-18, further comprising transmitting clock data to the volatile memory and the non-volatile memory via a shared clock line.

Aspect 20: A non-transitory computer-readable medium having program code recorded thereon, comprising: program code to transmit a first set of data to a volatile memory via a shared memory bus; and program code to transmit a second set of data to a non-volatile memory via the shared memory bus concurrently with the transmitting of the first set of data.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. An apparatus, comprising:
a shared data bus coupled to a non-volatile memory via a non-volatile memory data bus, and coupled to a volatile memory via a volatile memory data bus, the non-volatile memory data bus is a first subset of the shared data bus and the volatile memory data bus is a second subset of the shared data bus; and
a memory controller coupled to the shared data bus and both the non-volatile memory and the volatile memory via the shared data bus.

2. The apparatus of claim 1, in which the non-volatile memory is multi-bit flash memory and the volatile memory is random access memory (RAM).

3. The apparatus of claim 1, in which the non-volatile memory bus overlaps the volatile memory data bus in the shared data bus.

4. The apparatus of claim 1, further comprising a volatile memory control bus coupled to the volatile memory and a non-volatile memory control bus coupled to the non-volatile memory, the volatile memory control bus not shared with the non-volatile memory control bus.

5. The apparatus of claim 1, in which the non-volatile memory and the volatile memory share an address space, the non-volatile memory associated with a first portion of the address space and the volatile memory associated with a second portion of the address space.

6. The apparatus of claim 1, in which:
the shared data bus includes a set of data lanes;
the memory controller allocates a first portion of the set of data lanes to the non-volatile memory; and
the memory controller allocates a second portion of the set of data lanes to the volatile memory.

7. The apparatus of claim 1, in which:
the non-volatile memory includes a first mode register;
the volatile memory includes a second mode register;
the first mode register and the second mode register each indicate a configuration state of a plurality of configuration states;
the memory controller is configured to toggle, via a configuration command, the first mode register and the second mode register between the plurality of configuration states; and
the memory controller, the volatile memory, and the non-volatile memory are configured to couple based on the configuration state indicated by the first mode register and the second mode register.

8. The apparatus of claim 7, in which:
in a first configuration state of the plurality of configuration states, the non-volatile memory and the volatile memory share an address space, the non-volatile memory associated with a first part of the address space and the volatile memory associated with a second part of the address space; and
in a second configuration state of the plurality of configuration states:
the shared data bus includes a set of data lanes;
the memory controller allocates a first portion of the set of data lanes to the non-volatile memory; and
the memory controller allocates a second portion of the set of data lanes to the volatile memory.

9. The apparatus of claim 8, in which the first mode register and the second mode register indicate a third configuration state, the third configuration state enabling direct data transfer between the non-volatile memory and the volatile memory via the shared data bus.

10. The apparatus of claim 1, further comprising a clock line coupling a host to the non-volatile memory and the volatile memory, the clock line providing clock data to the non-volatile memory and the volatile memory, while the host is in a power saving mode and synchronous direct data transfer is occurring between the non-volatile memory and the volatile memory via the shared data bus.

11. The apparatus of claim 1, in which the volatile memory includes a plurality of volatile memory components, each volatile memory component coupled to the shared data bus via a respective volatile memory bus.

12. The apparatus of claim 11, in which each volatile memory component of the plurality of volatile memory components is random access memory (RAM) and includes a mode register.

13. A method, comprising:
transmitting a first set of data to a volatile memory via a shared memory bus; and
transmitting a second set of data to a non-volatile memory via the shared memory bus concurrently with the transmitting of the first set of data.

14. The method of claim 13, in which transmitting to the non-volatile memory is via a first part of a shared address space and transmitting to the volatile memory is via a second part of the shared address space.

15. The method of claim 13, in which transmitting to the non-volatile memory is via a first set of data lanes of the shared memory bus and transmitting to the volatile memory is via a second set of data lanes of the shared memory bus, the first set of data lanes being different than the second set of data lanes.

16. The method of claim 15, in which the transmitting the second set of data to the non-volatile memory occurs simultaneously with the transmitting of the first set of data.

17. The method of claim 13 further comprising transmitting a configuration command to a mode register hosted by one of the volatile memory or the non-volatile memory, the configuration command indicating a transmission technique to transmit and receive a third set of data via the shared memory bus.

18. The method of claim 13, further comprising transmitting, from one of the volatile memory or the non-volatile memory, a fourth set of data directly to the other of the volatile memory or the non-volatile memory, via the shared memory bus.

19. The method of claim 13, further comprising transmitting clock data to the volatile memory and the non-volatile memory via a shared clock line.

20. A non-transitory computer-readable medium having program code recorded thereon, comprising:
program code to transmit a first set of data to a volatile memory via a shared memory bus; and
program code to transmit a second set of data to a non-volatile memory via the shared memory bus concurrently with the transmitting of the first set of data.
